(19) United States
(12) Patent Application Publication
(10) Pub. No.: US 2024/0429744 A1
(43) Pub. Date: Dec. 26, 2024

(54) WIRELESS CHARGING PAD

(71) Applicant: International Business Machines Corporation, Armonk, NY (US)

(72) Inventors: Nicholas James Daffern, Truro (GB); William James Simmons, Fareham (GB); James Adam Nash, Upminster (GB)

(21) Appl. No.: 18/341,357

(22) Filed: Jun. 26, 2023

(51) Int. Cl. H02J 50/10; H02J 50/00; H02J 50/80; H02J 50/90

(52) U.S. Cl. CPC H02J 50/10; H02J 50/005; H02J 50/80; H02J 50/90

(57) ABSTRACT

Embodiments of the present invention provide computer-implemented methods, computer program product, and systems for charging an electronic device by induction. The pad includes a first conductive layer for connection to a first voltage; a second conductive layer for connection to a second voltage, with the second voltage is different to the first voltage, and a third conductive layer intervening between first and second layers, capable of forming different induction geometries to optimize the charging of the electronic device. The third layer includes a plurality of conductors, first transistors actuable to selectively interconnect neighboring ones of the plurality of conductors, and second transistors actuable to selectively connect each of the plurality of conductors to one of the first and second conductive layers.

### BACKGROUND

The present invention relates to wireless charging pads, specifically to a charging pad able to form different induction geometries to optimize the charging of an electronic device.

Wireless chargers allow electronic devices to be charged via inductive coupling, such that a physical connection is not required between the wireless charger and a battery of the electronic device. This is facilitated by a process called inductive conduction, wherein a current is passed through an induction coil, such that the moving electric charge creates a fluctuating magnetic field. The fluctuating magnetic field creates a moving electric charge, which creates an alternating electric current in the electronic device's induction coil. A rectifier of the electronic device converts the alternating current into a direct current, which can be used to charge the battery of the electronic device or provide operating power to the electronic device.

Wireless chargers have been used widely in the consumer device market. Portable personal electronic devices, such as smartphones, smartwatches and other wearables have many options of wireless chargers available. These include wireless charging pads suitable to be used on top of a table or a nightstand, as well as wireless charging pads inbuilt into furniture and central consoles of vehicles. As electric vehicles are becoming more prevalent, wireless charging alternatives for the electric vehicles are increasing. The convenience of cordless charging is desirable for the user. For electric vehicles, it means that the user of the electric vehicle can charge their car without getting out of their car, which opens up the possibility of different types of electric vehicle charging. For example, wireless charging points can be built into parking areas or roads.

Many conventional wireless chargers comprise a single transmitter coil in a wireless charging pad, and the electronic device to be charged has a receiver coil. The strength of the inductive coupling depends on the distance between the wireless charger and the electronic device; the closer they the stronger the coupling. The strength of the coupling also depends on the position or alignment of the electronic device in respect to the charger. For conventional chargers with a static induction coil, there is an optimal position for phone to be placed, because of the resultant shape of the magnetic field generated by the single transmitter coil. This means that the user must place their device in an optimal position, otherwise they will not get the best power transfer from the charger.

A known solution to the positioning problem is for a wireless charger to include multiple layers of overlapping coils within the wireless charger, so that the user can place their electronic device in more positions. As the number of coils increase however, the layers of coils must also increase, which leads to thicker and heavier wireless chargers. Additional layers results in a reduced power transfer because the electronic device is further away from the individual transmitter coils. This is also not desirable ergonomically, and the resultant circuitry of the charger is more complex.

There are some wireless chargers that allow the charging of multiple devices. These chargers have multiple induction coils re-built into them, so they always have an upper limit to the number devices they can charge. For example, a charger that has enough coils to charge two devices cannot charge more than two devices due to the physical limitation of the induction coils.

The size of the induction coil also affects the distance of power transfer to the electronic device. The bigger the coil, the greater distance a charge can travel. Conventional chargers have pre-built induction coils so the optimal distance of the pre-built coil cannot be changed.

Current wireless chargers conform to specific standards that are not compatible with other standards. This means that a wireless charger cannot charge an electronic device that conforms to another standard. This also means that a wireless charger cannot charge multiple devices that conforms to different standards.

### SUMMARY

According to an aspect of the present invention, there is provided a pad for charging an electronic device by induction, the pad comprising: a first conductive layer for connection to a first voltage; a second conductive layer for connection to a second voltage, where the second voltage is different to the first voltage; and a third conductive layer intervening between first and second layers, capable of forming different induction geometries to optimize the charging of the electronic device, where the third layer comprises: a plurality of conductors, first transistors actuable to selectively interconnect neighboring ones of the plurality of conductors, and second transistors actuable to selectively connect each of the plurality of conductors to one of the first and second conductive layers.

According to another aspect of the present application, there is provided a method for optimizing an induction geometry of a wireless charging pad, where the method comprises: detecting an electronic device; configuring the induction geometry in the wireless charging pad, where the induction geometry comprises at least one transmitter coil; determining a coupling value between the induction geometry and the electronic device; and transforming the induction geometry of the pad to optimize the coupling value.

The inductor geometries may comprise a single or multiple transmitter coils, to best accommodate the receiver coils in the electronic devices that require charging. Different inductor geometries are configured in the pad depending on the relative position of the electronic device to be charged and how many electronic devices require charging.

Advantageously, configuring different induction geometries for different situations means that an optimum transmission coil can be provided for the electrical devices to be charged. Different situations include a detection of an electrical device near the wireless charging pad, the electrical device changing position on the wireless charging pad and a detection of additional electrical devices near the wireless charging pad.

Conventionally, there is one optimum position for an electrical device to be placed in relation to a transmission coil of a wireless charging pad, because the transmission coil is pre-built and cannot be changed. Advantageously, the wireless charging pad of the present application is able to accommodate the charging of electrical devices on multiple positions relative to the wireless charging pad, because the transmission coils can be configured at any position on the wireless charging pad. This means that if the electrical device to be charged moves away from the device, the transmitter coil if the wireless charging pad will be transformed (e.g., made larger or increase the spiral density of the coil) such that the power transfer to the electrical device is not reduced.

Advantageously, the present application allows the wireless charging pad to be efficient in its energy management, since the induction geometry will only comprise transmitter coils that are required by the electrical device. For example, a receiver coil in a small device, such as an earphone, is smaller than a receiver coil in a larger device, such as a smart phone. Conventional wireless chargers have a pre-built transmitter coil that has a static coil shape and density. The present application can create a smaller transmitter coil that is appropriate for the smaller device, such that no excess energy is lost by providing a large transmitter coil.

Advantageously, the ability to configure different transmitter coil arrangements allows the charging of multiple devices on a single wireless charging pad, without being limited to the number of pre-built transmitter coils.

Advantageously, the present application allows electrical devices of different standards to be charged from the same wireless charging pad. The ability to configure different inductor geometries allows the wireless charging pad to provide appropriate transmitter coils to electrical devices, regardless of what standards the electrical devices may be using.

### BRIEF DESCRIPTION OF THE DRAWINGS

The present invention will now be described, by way of example only, with reference to preferred embodiments, as illustrated in the following figures:

FIG. 1 shows a part of a circuit diagram of a wireless charging pad;

FIGS. 2A and 2B show how a wireless charging pad can configure different inductor geometries for different electrical devices;

FIG. 3 shows how a current can be biased through the circuit of FIG. 1;

FIGS. 4A and 4B show how a wireless charging pad can configure different inductor geometries for different electrical devices;

FIGS. 5A and 5B show different controller arrangements; and

FIG. 6 is a block diagram depicting the hardware components of a system for prioritizing queued tasks waiting to access a resource associated with a resource manager in an application server.

### DETAILED DESCRIPTION

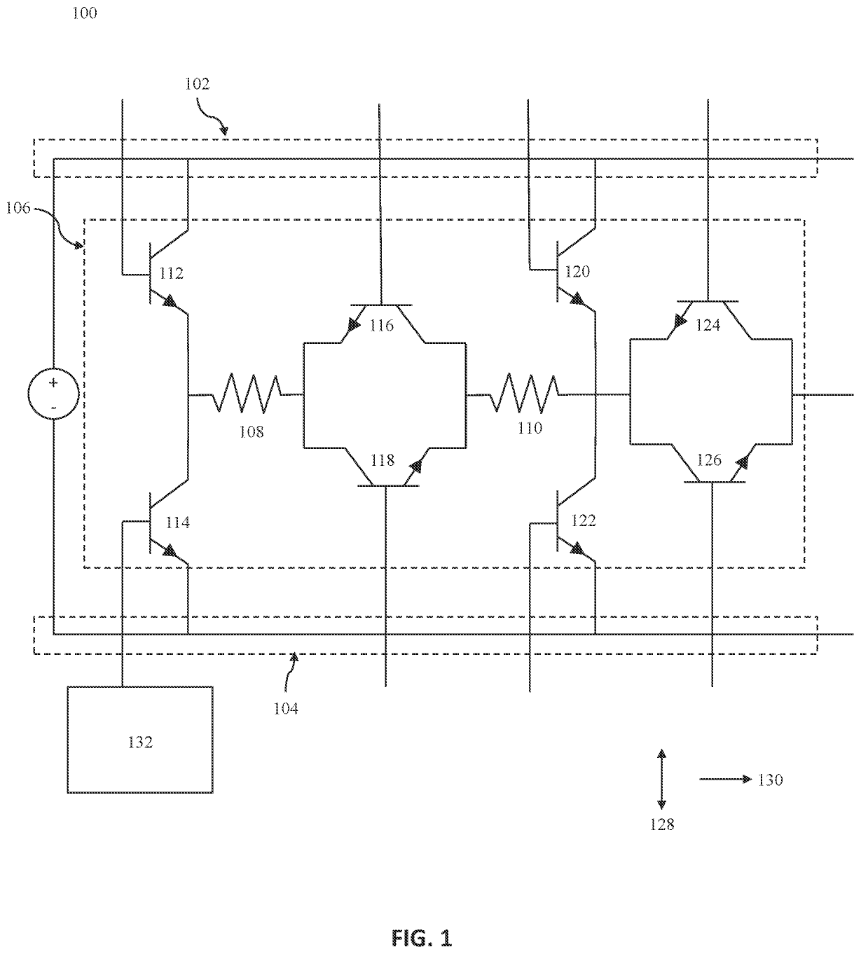

FIG. 1 shows a part of a circuit diagram of a pad 100 for charging an electronic device by induction, the pad 100 comprising: a first conductive layer 102 for connection to a first voltage; a second conductive layer 104 for connection to a second voltage, wherein the second voltage is different to the first voltage; and a third conductive layer 106 intervening between first 102 and second 104 layers, capable of forming different induction geometries to optimize the charging of the electronic device, wherein the third layer 106 comprises: a plurality of conductors 108, 110, first transistors 116, 118 actuable to selectively interconnect neighboring ones of the plurality of conductors 108, 110, and second transistors 112, 114, 120, 122, 124, and 126 actuable to selectively connect each of the plurality of conductors to one of the first 102 (i.e. a positive rail) and second 104 (i.e. a negative rail) conductive layers.

The circuit of FIG. 1 shows a part of a larger, extended circuit, that can have more conductors than the two conductors 108, 110 presented. The circuit of FIG. 1 can be replicated or extended in the directions 128 and 130 to form a larger circuit. For example, if conductor 108 was attached to four other conductors in a larger circuit, the conductor 108 would have four more pairs of first transistors attached to it, to fulfil all connections to the other conductors. A wireless charging pad capable of configuring different induction geometries will comprise a grid of conductors.

The circuit of FIG. 1 further comprises a controller 132 connected to control electrodes of the first 116, 118 and second transistors 112, 114, 120, 122 and operable to selectively actuate the first 116, 118 and second transistors 112, 114, 120, 122 to configure different inductor geometries.

The resultant inductor geometries may comprise a single or multiple transmitter coils, to best accommodate the electronic devices that need charging. Different inductor geometries are configured in the pad depending on the relative position of the electronic device to be charged and how many electronic devices require charging. The transmitter coils of the induction geometry are described by parameters including a coil position, a coil size, a coil density, and a coil shape.

The transmitter coil position relates to where in the wireless charging pad the transmitter coil is placed. For example, if an electronic device is placed on the top-right area of a wireless charging pad, the configured transmitter coil will most likely be positioned in the top-right area of the pad. The transmitter coil size relates to the maximum radius of the transmitter coil. The transmitter coil density relates to the number of spirals within the transmitter coil.

The resultant induction geometry can comprise circular spiral coils; conventional wireless chargers comprise a single circular spiral coil. The person skilled in the art will appreciate that the induction geometry can comprise coil shapes of other geometries, such as rectangular, hexagonal, or octagonal spiral coils. A combination of differently shaped coils can also be provided in a single wireless charger pad.

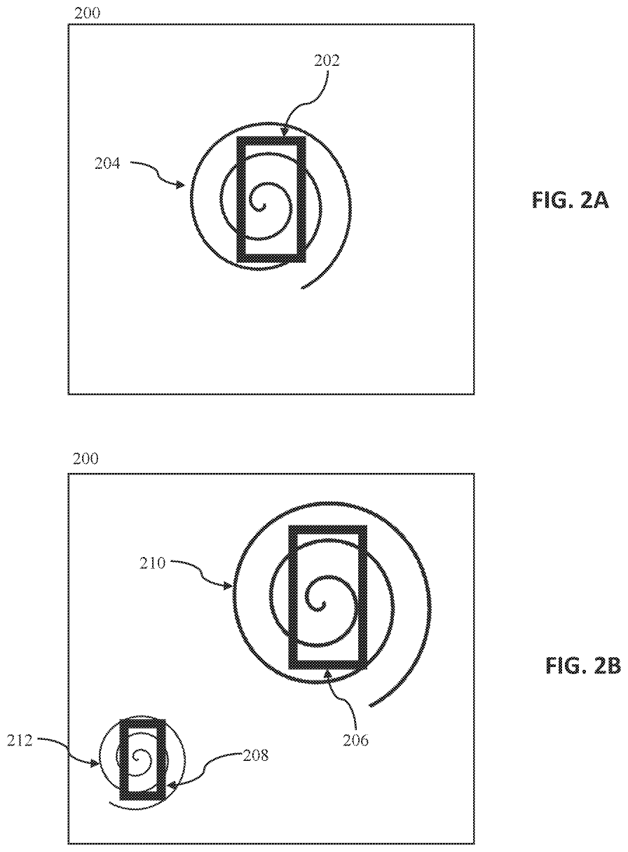

FIGS. 2A and 2B show examples of how the same wireless charging pad can configure different inductor geometries depending on the situation. The wireless charging pad 200 of FIGS. 2A and 2B is identical. It comprises the same number of conductors and transistors in both figures. The inductor geometries of the wireless charging pad can be changed or cleared to accommodate a different situation, for example, an electronic device may move position on the wireless pad, an additional electronic device may require charging from the same wireless charging pad, or an electronic device may be moved further away from the wireless charging pad.

In FIG. 2A, there is one electronic device 202 to be charged. The electronic device is placed near the center of the pad 200. The controller calculates the optimal size and placement of a transmitter coil 204 to result in the strongest induction coupling between the wireless charging pad 200 and the electronic device 202. The distance between the wireless charging pad 200 and the electronic device 202 is also taken into account. In this embodiment, the resultant inductor geometry comprises a single circular transmitter coil 204 positioned near the middle of the wireless charging pad 200.

In FIG. 2B, there are two devices 206, 208 placed near the wireless charging pad 200. The controller calculates the optimal number of transmitter coils, the optimal sizes of the transmitter coils and placement of the transmitter coils to best charge the two electronic devices. Each device 206, 208 has a receiver coil for charging. A circular spiral transmitter coil 210 is configured in a position near the electronic device 206. A circular spiral transmitter coil 212 is configured in a position near the electronic device 208. The circular spiral transmitter coil 210 has a larger size compared to the circular spiral transmitter coil 212. This is because the electronic device 206 requires more power transfer compared to electronic device 208. This may happen if, for example, electronic device 206 is further away from the wireless charging pad 200, or if electronic device 206 has a larger receiver coil. In this embodiment, the resultant inductor geometry comprises two circular spiral transmitter coils 210, 212 of different sizes.

To configure an inductor geometry in a wireless charging pad, a controller of the wireless charging pad comprises a CPU, a memory module, at least one decoder and an ammeter. The controller further comprises an ammeter, operable for taking readings of the circuit to determine the strength of the inductive coupling between an inductor geometry and the electronic device to be charged.

The CPU is given a list of conductor states that need to be created in order to achieve a particular induction geometry. Each conductor in the grid of conductors is stored in the memory module with the attributes, for example: (1) x-coordinate (integer), (2) y-coordinate (integer), (3) connect to positive (boolean), (4) connect to negative (boolean), (5) north, east, south, west connect (boolean). The integer attributes describe the state of the conductor, and the boolean connect attributes refer to whether the transistor in that position should be enabled or disabled.

At least one decoder is operable for controlling each transistor on and off. The instruction from the CPU is binary data that drives the decoder. The binary data may include the ID of a conductor and a reference of the transistor to be enabled. Each decoder converts the binary input from the CPU to drive a particular transistor. Each decoder has latches that start in a “low” state. The output from the decoder flips the latch state from a “low” to a “high” state. Each latch maintains the state of the “high” output until a further input from the CPU requires the transistor to be toggled to the other state or reset, keeping the transistor in the desired state when the input to the decoder changes.

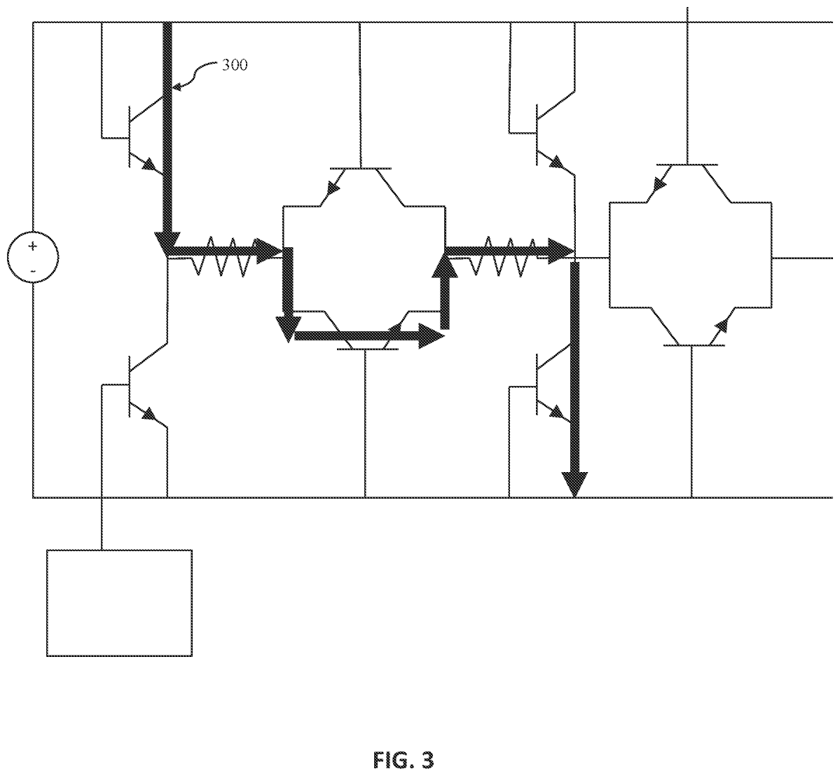

For example, FIG. 3 shows how a current can biased through the circuit of FIG. 1, such that the current passes through both conductors 108, 110 and then into the ground. The bold arrow 300 shows how the current passes through the circuit. The controller 132 determines that transistors 112, 118 and 122 need to be turned on, and drives at least one decoder to activate the required transistors.

The use of decoders and latches allows the CPU to send instructions to each transistor one by one, while the states of the other transistors are locked. A reset line is built in connected to all the latches of the decoders, so that the states of all the latches can be reset and the induction geometry of the circuit cleared.

A binary instruction, is generated by the CPU and transmitted to the decoder. The states of the transistors must first be encoded. The ID of a specific conductor within a grid of conductors can be found using a formula, for example:

$$( ( width\_of \_conductors + 1 ) * y ) + x )$$

where width_of_conductors is the width of the conductor grid, x is the x-coordinate of the conductor and y is the y-coordinate of the conductor.

Each conductor of the grid of conductors is assumed to have ownership of the transistors that are in the “east” and “south” directions of the conductor. The conductor also has ownership of the transistors that are in the “positive” and “negative” directions of the conductor, that which connect the conductor to the first (positive rail) and second (negative rail) conductive layers. The transistor states can be represented with two bits, for example:
00=Enable “negative”
11=Enable “south”
10=enable “positive”
01=enable “east”

Therefore, given a 10×10 grid of conductors, the ID of the conductor at position (4,4) of the grid would be 44, or 101100 in binary form. To enable the “east” transistor of the (4,4) conductor, the “01” bits that represent the “enable east” state is appended or added to the conductor ID. The resultant binary instruction becomes 10110001. This binary instruction is transmitted from the CPU to the decoder to enable the specific transistor. In this way, each transistor can be managed by the controller.

By selectively actuating transistors in a circuit, different inductor geometries that include at least one transmitter coil, can be configured in the wireless charging pad. The parameters of a coil (e.g., position, size, density and shape) are used to form the binary instructions used to drive the transistors. The coil position may be indexed, for example, by the first conductor in the transmitter coil. The transmitter coil shape and size parameters govern the coil's radius in the x and y directions of the grid of conductors.

The following describes an example method of how a transmitter coil is generated using the parameter data. There are various spiral functions that can be used to calculate the transmitter coil, for example, Fermat's spiral generates a spiral of equal dimension in the x and y direction i.e., rx=ry, where rx is the maximum radius of the transmitter coil in the x-direction and ry is the maximum direction in the y-direction. If the transmitter coil is centered around [0,0], the spiral equation would be:

$$x = \frac{r}{t} cos ( t )$$

$$y = \frac{r}{t} sin ( t )$$

where t is a parameter that is stepped through to generate a spiral, and r is the radius of the spiral.

If t=0 corresponds to a position that is exactly at the center of a conductor, the center of the spiral will not necessarily by at exactly [0,0]. Therefore, an adjustment must be made to the spiral equation.

To generate a circular spiral transmitter coil, the following example method can generate a list of transistors to be switched on for a given spiral function, at a given starting position. The list of transistors is translated into the binary data by the CPU. The CPU of the controller can:
(1) Set t=0 and evaluate x and y, to determine x(t) and y(t)
(2) Increase t by an increment of Δt and evaluate the new values of x and y, to determine x(t+Δt) and y(t+Δt)
(3) Evaluate the distance of the coordinate [x(t+Δt), y(t+Δt)] to the center of all cells adjacent to [x(t), y(t)]
(4) Repeat steps (2) and (3) and add an increment of Δt
(5) Stop when the distance between [x(t+n*Δt), y(t+n*Δt)] to any of the cells adjacent to [x(t), y(t)] is less than the distance of [x(t+n*Δt), y(t+n*Δt)] to [x(t), y(t)]
(6) Set the cell closest to [x(t+n*Δt), y(t+n*Δt)] to be [x′, y′]
(7) Select the transistor between (x(t), y(t)) and (x′, y′) and record the transistor to memory
(8) Measure the distance between [x(t), y(t)] and the centre of the coil. If the distance is smaller than a given end radius (rₘᵢₙ) from the centre, go to step (10). Otherwise, go to step (9)
(9) Repeat steps (2)-(8), using the current value of (x′, y′) instead of [x(t), y(t)]
(10) Record the transistor between (x′, y′) and a second conductive layer (i.e., a negative rail)

The transmitter coil in an induction geometry can be of a different shape, such as a square spiral or a hexagonal spiral. To configure the different shapes, alternative algorithms can be used to generate the list of conductors to be switched on.

An electrical device to be charged must first be detected to calculate the induction geometry required. To detect the presence of a receiver coil in the electronic device, an induction geometry comprising different configurations of transmitter coils are formed in the circuit of the wireless charging pad. Different sizes of transmitter coils are formed in different parts of the wireless charging pad, to detect new electronic devices. This requires a detection phase in which a pad is polled by forming transmitter coils at computed locations. The detection phase is run periodically to ensure new devices are detected.

One way of performing the detection phase is using a parity technique to limit the number of areas to be polled. A minimum size of transmitter coil is set; the minimum size can relate to the smallest expected receiver coil of an electronic device. The third conductive layer of the wireless charging pad is split into smaller areas, wherein the size each of the smaller area is equal to a quarter of the minimum size of the transmitter coil. The center of each area is used as an initial polling point. This limits the space required to analyze, while providing enough resolution to receive useful coupling data.

Another way of performing the detection phase is using a probability density technique. As electronic devices are charged, the controller monitors information about the position of each electronic device being charged from the wireless charging pad. The position information is used to generate a probability density map over the wireless charging pad. Higher probabilities correspond to areas where devices are often placed. Each placement area is represented as a bell curve in three dimensions (x, y, coupling), where the curves are summed to create the probability density. This allows the system to use historical information about where previous electronic devices were placed, to better choose a starting position for the detection phase. For example, transmitter coils can be generated in the areas where electronic devices are more likely to be placed, before moving onto other areas with a lower probability density.

Another way of performing the detection phase uses a proximity probability density technique. This technique avoids creating transmission coils in areas of the wireless charging pad already have a device placed on it. A new coil should be generated in an area of the pad that is not occupied already by an electronic device, and it is likely that the receiver coil in the electronic device is smaller than the total size of the electronic device itself. The coupling strength measurement alone cannot be used to deduce the dimensions of the electronic device being charged. The average size of the electronic devices, however, can be inferred by using proximity probability density. When multiple devices are being charged on the wireless charging pad, vectors between the central points of the multiple devices are measured and stored over time. The magnitude of the vectors is stored independently for a defined class of coil size. For example, the average magnitude of the vector may be 1 cm for a small transmitter coil and 20 cm for a large transmitter coil.

Over time, a relationship between the size of coil and magnitude of the vector can be established. When a new transmitter coil is configured, a circle of radius equal to the mode of the magnitude associated with the new transmitter coil size is placed around the center of the new transmitter coil. This radius corresponds to the most likely class of device given a coil size. The probability density for all coordinates within the circle are uniformly lower than the probability density at edge of the circle. The circle is added to a probability density map that represents the positions of other devices that on the wireless charging pad. This technique increases the chance of finding a pair of devices that are commonly charged together and prevents polling the space that is physically occupied by other electronic devices, that have already been detected by the controller.

Once an electronic device has been detected, the transmission coil that has found a corresponding receiver coil needs to be transformed to provide the highest strength of coupling. This requires an optimization phase. The transformations may include, for example, moving the co-ordinates of the coil, stretching the coil, changing the size of the coil, or changing the density of coils within the coil. Once the maximum coupling value is achieved, the optimization step stops. The maximum coupling value can be inferred, for example, by attempting all the available transformations of the transmission coil and selecting the configuration that provided the highest coupling value.

The ammeter is used to measure the amount of additional current that is drawn from the grid when the induction geometry is generated, to determine the strength of the induction coupling between the transmitter coil of the wireless charging pad and the receiver coil of the electronic device. A change in the amount of current being drawn from the grid indicates that there is either a new device placed near the wireless charging pad waiting to be charged, or the position of an existing electronic device that was already charging has changed.

When the electronic device has been fully charged, or if the electronic device is removed from the pad, the ammeter will detect a difference in the current being drawn from the wireless charging pad. When this difference is detected, the controller of the wireless charging pad will run through the detection phase and the optimization phase again. The current drawn from the wireless charging pad may change if the position of an electronic device has changed, but it still being charged. In this case, the controller may only run the optimization phase again to readjust the transmitter coil associated with the electronic device, to transform the transmitter coil to provide the best coupling value.

The optimization phase can additionally use information about the electronic device to transform the transmission coil in the wireless charging pad. The information could include data such as electronic device model, dimensions of device, size of receiver coil and maximum coupling value. The information could be received by the controller, from the electronic device, via Bluetooth, Wi-Fi, NFC or another communication method. Using the information, the controller may only need to determine where in the wireless charging pad an optimum transmitter coil needs to be placed. The optimum size and shape of the transmitter coil can be calculated using the information. Of course, if the electronic device moves away from the wireless charging pad, a larger or a denser coil may be required.

The detection phase and optimization phase can use machine learning techniques to improve the configuration of the inductor geometry, which includes transmitter coils. For example, the training set for the detection phase model could comprise historical coordinate data of where previous electronic devices were placed. The training set of the optimization phase model could comprise historical data of all previously coupled coils.

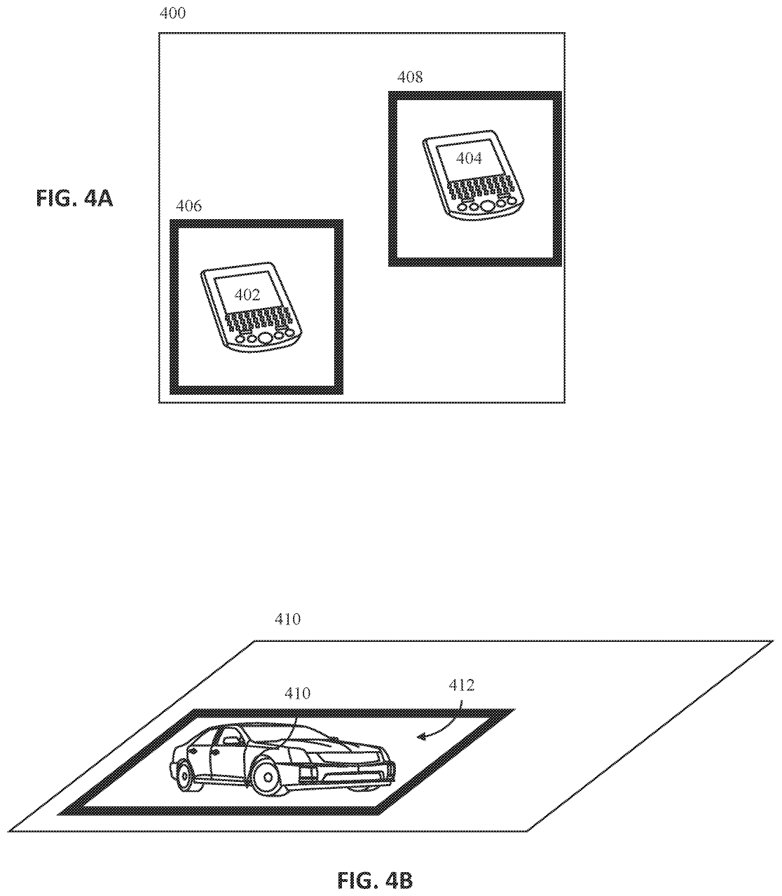

FIG. 4A shows a single wireless charging pad 400 being used by two different electronic devices 402, 404. The wireless charging pad configures two transmitter coils in areas 406 and 408 to optimize the coupling value and provide the highest power transfer to both devices. The wireless charging pad 400 can be a standalone device, suitable for using on top of a table. It can alternatively be built into a piece of furniture or in the central console of a car.

FIG. 4B shows a single wireless pad 410 being used to charge a vehicle 412. The controller of the wireless charging pad configures a single transmitter coil in area 412 to optimize the coupling value between the pad and the vehicle. In response to another vehicle being detected on the wireless charging pad, another transmitter coil may be created to accommodate the other vehicle. The wireless charging pad 410 can be built into a road, a garage floor, or into a specialized charging station.

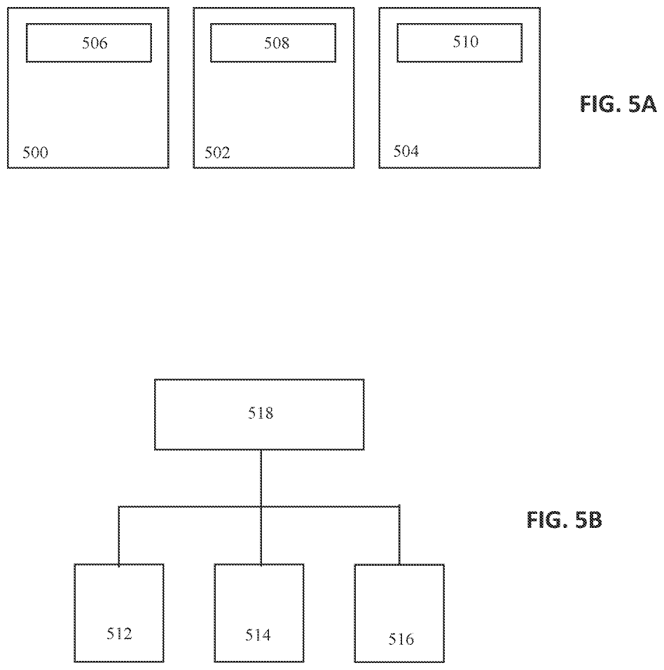

FIG. 5A shows how each wireless charging pad 500, 502, 504 comprises its own internal controller 506, 508, 510. The three wireless charging pads are not connected, and each controller manages its respective pad. FIG. 5B shows how three wireless charging pads 512, 514, 516 are connected to a single, external controller 518.

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “processing system”, “processing module”, “processing circuit”, “processor”, and/or “processing unit” may be used interchangeably and may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing system, processing module, module, processing circuit, and/or processing unit may be, or further include, memory and/or an integrated memory element, which may be a single memory device, a plurality of memory devices, and/or embedded circuitry of another processing system, processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing system, processing module, module, processing circuit, and/or processing unit includes more than one processing device, the processing devices may be centrally located (e.g., directly coupled together via a wired and/or wireless bus structure) or may be distributed, located (e.g., cloud computing via indirect coupling via a local area network and/or a wide area network). Further note that if the processing system, processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing system, processing module, module, processing circuit, and/or processing unit executes, hard coded and/or operational instructions corresponding to at least some of the steps and/or functions illustrated in one or more of the Figures. Such a memory device or memory element can be included in an article of manufacture.

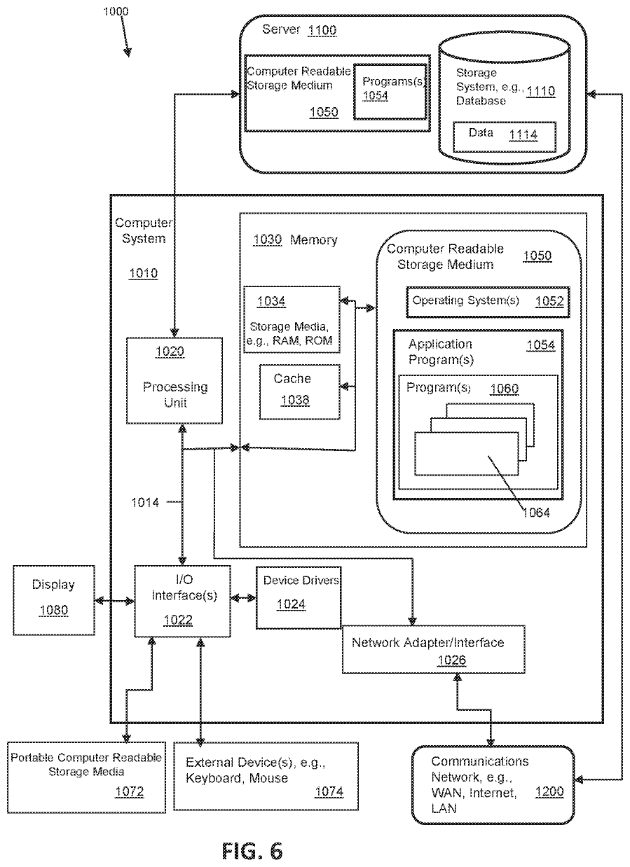

The system described in the present invention may include internal and external hardware components, as described in further detail below with respect to FIG. 6. It should be appreciated that FIG. 6 provides only an illustration of one implementation and does not imply any limitations with regard to the environments in which different embodiments may be implemented. Many modifications to the depicted environment may be made. In other embodiments, the system described in the present invention may operate in a cloud computing environment, as depicted in FIG. 6.

Referring to FIG. 6, a system 1000 includes a computer system or computer 1010 shown in the form of a generic computing device. The method of the present invention, for example, may be embodied in a program(s) 1060 (FIG. 6) embodied on a computer readable storage device, for example, generally referred to as memory 1030 and more specifically, computer readable storage medium 1050 as shown in FIG. 6. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 6 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 6 as program modules 1064. The program 1060 and program modules 1064 can execute specific steps, routines, sub-routines, instructions or code, of the program.

Embodiments of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 6, the system 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method of the present invention, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The program 1060 may include a keyword system or natural language processing system 1064 that can detect an electronic device, configure the induction geometry in the wireless charging pad, wherein the induction geometry comprises at least one transmitter coil, determine a coupling value between the induction geometry and the electronic device, and transform the induction geometry of the pad to optimize the coupling value The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (Saas): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

What is claimed is:

1. A pad for charging an electronic device by induction, the pad comprising:
a first conductive layer for connection to a first voltage;
a second conductive layer for connection to a second voltage, wherein the second voltage is different to the first voltage; and
a third conductive layer intervening between first and second layers, capable of forming different induction geometries to optimize the charging of the electronic device, wherein the third layer comprises:
a plurality of conductors,
first transistors actuable to selectively interconnect neighboring ones of the plurality of conductors, and
second transistors actuable to selectively connect each of the plurality of conductors to one of the first and second conductive layers.

2. The pad of claim 1 further comprising: a controller connected to control electrodes of the first and second transistors and operable to selective actuate the first and second transistors to configure the different inductor geometries.

3. The pad of claim 2, wherein the controller is located within the third conductive layer.

4. The pad of claim 2, wherein the controller is located adjacent to the third conductive layer.

5. The pad of claim 2, wherein the pad is connected to an external controller.

6. The pad of claim 1, wherein the inductor geometries comprise at least one circular spiral coil.

7. The pad of claim 1, wherein the inductor geometries comprise at least one rectangular spiral coil.

8. The pad of claim 1, further comprises a casing that protects the components of the pad.

9. The pad of claim 1, wherein the plurality of conductors comprises conductors of a square shape, wherein each conductor is capable of having six connections.

10. The pad of claim 1, wherein the plurality of conductors comprises conductors of a hexagonal shape, wherein each conductor is capable of having eight connections.

11. A computer-implemented method for optimizing an induction geometry of a wireless charging comprising:
detecting an electronic device;
configuring the induction geometry in the wireless charging pad, wherein the induction geometry comprises at least one transmitter coil;
determining a coupling value between the induction geometry and the electronic device; and
transforming the induction geometry of the pad to optimize the coupling value.

12. The computer-implemented method of claim 11, wherein the detecting the electronic device measures an amount of current drawn from the pad, by the electronic device.

13. The computer-implemented method of claim 11, wherein the detecting the electronic device uses a pressure monitoring component attached to the pad, which detects a position of the electronic device.

14. The computer-implemented method of claim 11, wherein the detecting the electronic device uses a parity technique to detect a position of the electronic device.

15. The computer-implemented method of claim 11, wherein the detecting the electronic device uses a probability density technique to detect a position of the electronic device.

16. The computer-implemented method of claim 11, wherein the detecting the electronic device uses a proximity probability density technique to detect a position of the electronic device.

17. The computer-implemented method of claim 11, wherein the transforming the induction geometry of the pad includes changing the position and size of the at least transmission coil.

18. A computer program product comprising:
one or more computer readable storage media and program instructions stored on the one or more computer readable storage media, the program instructions comprising:
program instructions to detect an electronic device;
program instructions to configure the induction geometry in the wireless charging pad, wherein the induction geometry comprises at least one transmitter coil;
program instructions to determine a coupling value between the induction geometry and the electronic device; and
program instructions to transform the induction geometry of the pad to optimize the coupling value.

19. The computer program product of claim 18, wherein the program instructions to detect the electronic device comprises program instructions to measure an amount of current drawn from the pad, by the electronic device.

20. The computer program product of claim 18, wherein the program instructions to detect the electronic device comprises program instructions to use a pressure monitoring component attached to the pad to detects a position of the electronic device.
